(19) United States
(12) Patent Application Publication
(10) Pub. No.: US 2025/0355123 A1
(43) Pub. Date: Nov. 20, 2025

(54) MODULAR DETECTOR ARCHITECTURE

(71) Applicant: CARESTREAM HEALTH, INC., Rochester, NY (US)

(72) Inventors: Luca BOGONI, Philadelphia, PA (US); Xiaohui WANG, Pittsford, NY (US); Jim ZHANG, Beijing (CN)

(21) Appl. No.: 18/871,166

(22) PCT Filed: Jun. 26, 2023
(86) PCT No.: PCT/US2023/069062

§ 371 Date: Dec. 3, 2024

Related U.S. Application Data
(60) Provisional application No. 63/357,026, filed on Jun. 30, 2022.

(51) Int. Cl. G01T 1/20; G01T 1/24

(52) U.S. Cl. CPC G01T 1/20188; G01T 1/244

(57) ABSTRACT

A modular digital radiographic detector is constructed to have a housing for receiving and securing detector components. One or more removable and interchangeable modular detector components maybe swapped with an identical component or a replacement version of the removed modular detector component. Compartmental openings are formed in the housing and include electrical connectors for integrating one or more replacement detector components into the detector's communication system.

### BACKGROUND OF THE INVENTION

The subject matter disclosed herein relates to digital radiographic (DR) detectors. In particular, to modular digital detectors constructed from a number of interchangeable detector sections or components.

X-ray detectors are typically manufactured as integrated devices with components incorporated as part of a fixed architecture. The architecture typically remains static during manufacture and through the life cycle of the product with possible exception for the battery, or other simple mechanical parts such as the battery latch, bumper, handle, which could be replaced and possibly updated. Thus, the detector may integrate components, possibly from several suppliers to address various intrinsic and extrinsic aspects. Examples of intrinsic aspects include: (1) physical imaging: the x-ray imager may include, but is not limited to, a-Si, a-Se, IGZO, LTPS, or CMOS panel with any kind of seintillator that converts the x-ray signal to an electric signal; and (2) functionalities, such as A/D conversion units, detector control/monitor electronics, power management system, image storage unit, image read-out electronics, and communication interface (wired and wireless).

Examples of extrinsic aspects include (1) packaging and ergonomics: coating and IP rating, weight, ruggedness, and handle; (2) serviceability: battery and diagnostic (self-testing and shock sensor); and (3) post processing off the detector for, among other aspects, image quality processing improvements and enhancements.

The discussion above is merely provided for general background information and is not intended to be used as an aid in determining the scope of the claimed subject matter.

### BRIEF DESCRIPTION OF THE INVENTION

A modular digital radiographic detector is constructed to have a housing for receiving and securing detector components. One or more removable and interchangeable modular detector components may be swapped with an identical component, a replacement version, or an upgraded version of the removed modular detector component. Compartmental openings are formed in the housing and include electrical connectors for integrating one or more replacement detector components into the detector's communication and processing system. An advantage that may be realized in the practice of some disclosed embodiments of the modular detector is an easier and cheaper upgrade without requiring the purchase of an entire new detector.

While typical detector manufacturing may be directed to optimizing the detector construction based on a fixed architecture, the modular construction described herein has the benefit of quality control, and reduces the number of product variations to support in the field. The fixed architecture has several drawbacks including: obsolesce of components and technology; inability to upgrade/update products with functionality to support newer requirements, long development time from design to final product delivery, and high service cost as the full detector has to be replaced when a single component fails. In fact, component commitments in early stages might yield products with components that may have already been supplanted with newer versions having better performance or more desirable characteristics.

This modular approach allows interchangeable components to be integrated into a common frame, or housing, in a manner similar to how a PC is assembled. This flexibility facilitates an approach toward x-ray detectors as systems with open architecture design that are assembled and tested rather than as monolithic devices. Current detectors, even though they include various components, possibly from different sources/manufacturers, still require significant efforts to design, test, validate, obtain regulatory clearance and manufacture. Such efforts are costly and impact the time to market, even when updating a small component such as a communications module or increasing memory capacity by updating a memory module.

On the other hand, when components have well-defined interfaces, these can be developed and tested independently. Detectors may then be configured depending on need, market demand and can incorporate the latest technologies. While detectors are medical devices, various configurations may be validated by a manufacturer at component integration time. Configurations may receive regulatory clearance for a class/set of interchangeable components. This flexibility affords a prompt response to customers' needs and technological innovations. Additionally, field upgradability may be performed on validated configurations simply by shipping components and running automated tests either remotely or at a customer site.

Building DR detectors using a modular approach affords a rapid evolution of technology with components becoming off-the-shelf (commoditized) leading to a reduction in manufacturing costs and prices to customers. Modular design may lead to a detector retaining value for a longer period of time as their life may be extended by upgrading components with the latest technologies. Refurbishing of detectors may become a full business opportunity and, as components costs decrease dramatically, may translate into building disposable/recyclable detectors.

A manufacturer may offer a set of validated configurations tailored to meet a specific task, whether clinical or NDT (non-destructive testing). Consumers may thus be able to select from a set of configurations online and receive the detector suitable for the needed task or help manufacturers validate use cases. Conversion kits may be available to convert detectors across various configurations to support various use cases.

A modular architecture for a DR detector may include a frame or housing with a communication backbone(s) onto which various components can be connected; and a minimal set of components such as an imager, to convert x-rays into electronic signals, readout ICs, analog to digital conversion, detector control and monitor electronics, power management system, image storage unit and communication interface (wired and wireless). One embodiment of the present invention modifies how x-ray detectors may be designed, tested, validated, assembled, cleared (regulatory) and manufactured. A new modular architecture is disclosed whereby the detector is constructed by integrating various components onto a common physical frame/housing with a processing system communication backbone.

In one embodiment, a digital radiographic detector includes a housing for receiving detector components, and two or more removable modular detector components, each interchangeable with an identical replacement component or another version of the modular detector component.

In one embodiment, a method of swapping a modular component of a digital radiographic detector includes removing the modular component from an opening in a back side of the DR detector by manually detaching an electrical connector built into the modular component from an electrical connector built into the detector opening. The removed modular component is replaced with a substitute or upgraded modular component by inserting the new modular component into the opening such that the electrical connector of the new modular component electrically engages the electrical connector built into the opening.

In one embodiment, a digital radiographic (DR) detector includes a housing and a processing system within the housing which controls operations of the DR detector. A plurality of modular components within the housing are in digital communication with the processing system for receiving at least control signals from the processing system and for at least transmitting data to the processing system. The housing comprises a plurality of openings each corresponding to at least one of the modular components, wherein each of the openings includes an electrical connector configured to engage an electrical connector on each of the plurality of modular components.

The summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings below are intended to be drawn neither to any precise scale with respect to relative size, angular relationship, relative position, or timing relationship, nor to any combinational relationship with respect to interchangeability, substitution, or representation of a required implementation, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic perspective view of an exemplary digital x-ray imaging system;

FIG. 2 is a schematic diagram of a two dimensional imaging pixel array in a radiographic detector;

FIG. 3 is a perspective diagram of an exemplary DR detector;

FIG. 4 is a cross section diagram of an exemplary DR detector;

FIG. 5 is a framework housing illustrating various slot locations (A, B, C, D) where components may be connected, similar to how batteries are clipped in currently manufactured detectors; and

FIG. 6 is a schematic illustration of a detector processing system in digital electric communication with removeable detector components.

### DETAILED DESCRIPTION OF THE INVENTION

This application claims priority to U.S. Patent Application Ser. No. 63/357,026, filed Jun. 30, 2022, in the name of Bogoni et al., and entitled MODULAR DETECTOR ARCHITECTURE, which is hereby incorporated by reference herein in its entirety.

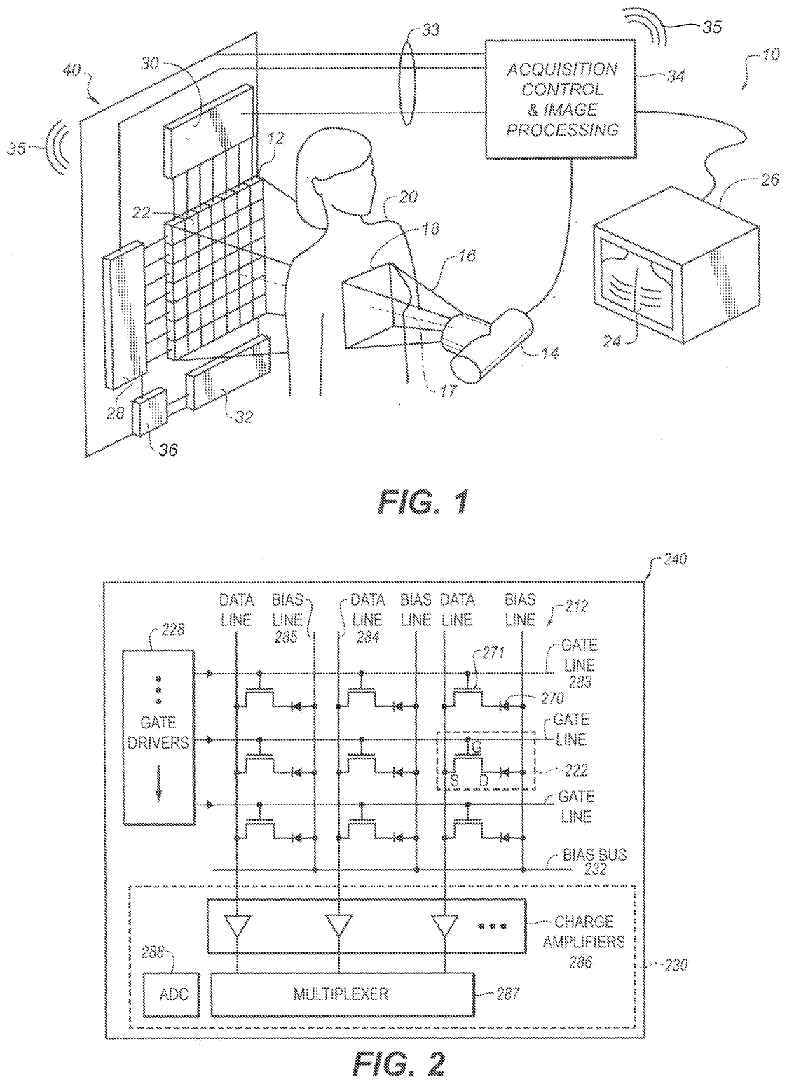

FIG. 1 is a perspective view of a digital radiographic (DR) imaging system 10 that may include a DR detector 40 (shown without a housing for clarity of description), an x-ray source 14 configured to generate radiographic energy (x-ray radiation), and control station that includes a digital monitor, or electronic display, 26 configured to display images 24 captured by the DR detector 40, and a processing system 34 for controlling operation of the (DR) imaging system 10, according to one embodiment. The DR detector 40 may include a two dimensional array 12 of detector cells 22 (imaging pixels or photosensors), arranged in electronically addressable rows and columns. Dimensions of the detector may include 17×17 cm, 35×35 cm, or 35×43 cm, for example. The DR detector 40 may be positioned to receive x-rays 16, passing through an object 20, emitted by the x-ray source 14. As shown in FIG. 1, the radiographic imaging system 10 may use an x-ray source 14 that emits collimated x-rays 16, e.g. an x-ray beam, selectively aimed at a region of interest 18 and passing through a preselected object 20 such that the emitted x-rays 16 fall on an imaging region, i.e., imaging pixels 22, of the DR detector 40. The x-ray beam 16 may be attenuated by varying degrees along its plurality of rays according to the structure, e.g., varying thickness, of the object 20, which attenuated x-rays are detected by the array 12 of imaging pixels 22. The DR detector 40 may be positioned, as much as possible, in a perpendicular relation to a central ray 17 of the plurality of rays 16 emitted by the x-ray source 14. The array 12 of individual imaging pixels 22 may be electronically addressed (scanned) by their position according to column and row. As used herein, the terms “column” and “row” refer to the vertical and horizontal arrangement of the photosensor cells 22 and, for clarity of description, it will be assumed that the rows extend horizontally and the columns extend vertically. However, the orientation of the columns and rows is arbitrary and does not limit the scope of any embodiments disclosed herein. Each individual imaging pixel 12 may be scanned by interchangeable modular readout components 28, 30, described herein, to determine a stored voltage level generated therein by an incoming x-ray energy level. The voltage level stored in each imaging pixel 12 may be read out by the modular read out components 28, 30, and stored electronically as a digitized numerical value. As is well known, an A/D converter component may be used to convert the stored voltage level in each pixel 12 into a digital value. A higher numerical value may be understood to represent a greater amount of x-ray energy absorbed by an individual imaging pixel 12 during an imaging procedure of an object 20.

In one exemplary embodiment, the rows of photosensitive cells 22 may be scanned one or more at a time by a modular electronic scanning component 28 so that the exposure data from the array 12 may be transmitted to modular electronic read-out component 30. Each photosensitive cell 22 may independently store a charge proportional to an intensity, or energy level, of the attenuated radiographic radiation, or x-rays, received and absorbed in the cell. Thus, each photosensitive cell 22, when read-out, provides information defining a pixel of a radiographic image 24, e.g. a brightness level or an amount of energy absorbed by the pixel, that may be digitally decoded by image processing electronics 34 and transmitted to be displayed by the digital monitor 26 for viewing by a user. A modular electronic bias component 32 is electrically connected to the two-dimensional detector array 12 to provide a bias voltage to each of the photosensitive cells 22.

Each of the modular bias component 32, the modular scanning component 28, and the modular read-out component 30, may communicate with an acquisition control and image processing unit 34 over a connected cable 33 (wired), or the DR detector 40 and the acquisition control and image processing unit 34 may be equipped with a wireless transmitter and receiver to transmit radiographic image data wirelessly 35 to the acquisition control and image processing unit 34. The acquisition control and image processing unit 34 may include a processor and electronic memory (not shown) to control operations of the DR detector 40 as described herein, including control of interchangeable modular components 28, 30, and 32, for example, by use of programmed instructions, and to store and process image data. The acquisition control and image processing unit 34 may also be used to control activation of the x-ray source 14 during a radiographic exposure, controlling an x-ray tube electric current magnitude, and thus the fluence of x-rays in x-ray beam 16, and/or the x-ray tube voltage, and thus the energy level of the x-rays in x-ray beam 16.

A portion or all of the acquisition control and image processing unit 34 functions described herein may reside in the detector 40 in an on-board processing system 36 which may include a processor and electronic memory to control operations of the DR detector 40 as described herein, including control of modular components 28, 30, and 32, by use of programmed instructions, and to store and process image data similar to the functions of standalone acquisition control and image processing system 34. The image processing system 36 may perform image acquisition and image disposition functions as described herein. The image processing system 36 may control image transmission and image processing and image correction on board the detector 40, and transmit corrected digital image data therefrom. Alternatively, acquisition control and image processing unit 34 may receive raw image data from the detector 40 and process the image data and store it, or it may store raw unprocessed image data in local memory, or in remotely accessible memory.

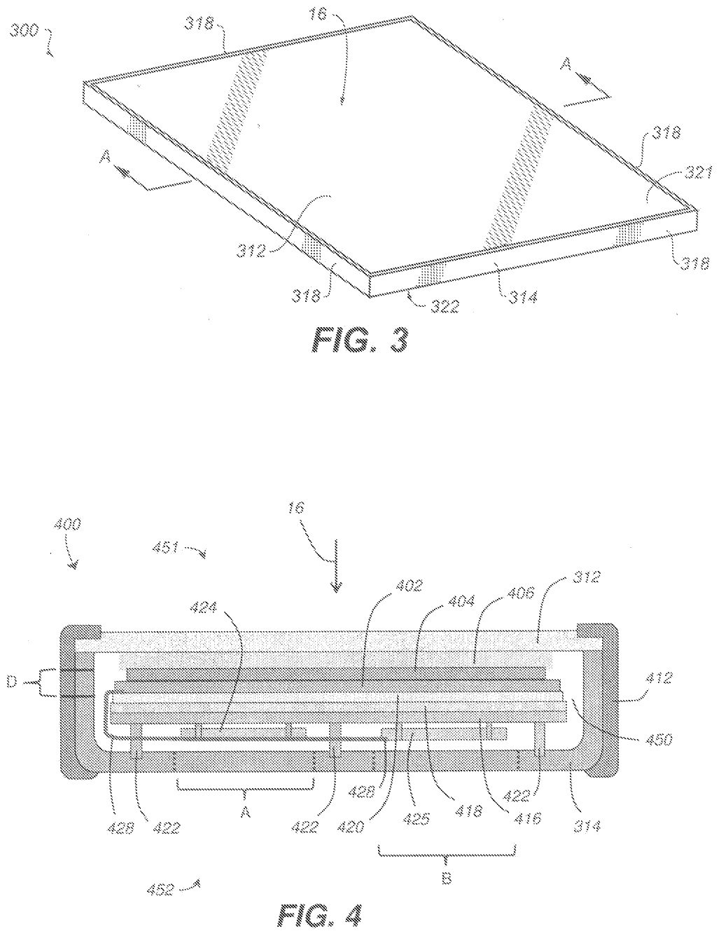

With regard to a direct detection embodiment of DR detector 40, the photosensitive cells 22 may each include a sensing element sensitive to x-rays, i.e. it absorbs x-rays and generates an amount of charge carriers in proportion to a magnitude of the absorbed x-ray energy. A switching element in each cell 22 may be configured to be selectively activated to read out the charge level of a corresponding x-ray sensing element. With regard to an indirect detection embodiment of DR detector 40, photosensitive cells 22 may each include a sensing element sensitive to light rays in the visible spectrum, i.e. it absorbs light rays and generates an amount of charge carriers in proportion to a magnitude of the absorbed light energy, and a switching element that is selectively activated to read the charge level of the corresponding sensing element. A scintillator, or wavelength converter, may be disposed over the light sensitive sensing elements to convert incident x-ray radiographic energy to visible light energy. Thus, in the embodiments disclosed herein, it should be noted that the DR detector 40, or DR detector 300 in FIG. 3 or DR detector 400 in FIG. 4, may include an indirect or direct type of DR detector.

Examples of sensing elements used in sensing array 12 include various types of photoelectric conversion devices (e.g., photosensors) such as photodiodes (P-N or PIN diodes), photo-capacitors (MIS), photo-transistors or photoconductors. Examples of switching elements used for signal read-out include a-Si TFTs, oxide TFT's, MOS transistors, bipolar transistors and other p-n junction components.

FIG. 2 is a schematic diagram 240 of a portion of a two-dimensional array 12 for a DR detector 40. The array of photosensor cells 212, whose operation may be consistent with the photosensor array 12 described above, may include a number of hydrogenated amorphous silicon (a-Si:H) n-i-p photodiodes 270 and thin film transistors (TFTs) 271 formed as field effect transistors (FETs) each having gate (G), source(S), and drain (D) terminals. In embodiments of DR detector 40 disclosed herein, such as a multilayer DR detector (400 of FIG. 4), the two-dimensional array of photosensor cells 12 may be formed in a device layer that abuts adjacent layers of the DR detector structure, which adjacent layers may include a rigid glass layer or a flexible polyimide layer or a layer including carbon fiber without any adjacent rigid layers. A plurality of gate driver circuits 228 may be formed as an interchangeable modular component and is electrically connected to a plurality of gate lines 283 which control a voltage applied to the gates of TFTs 271. A plurality of readout circuits 230 may be formed as an interchangeable modular component and is electrically connected to data lines 284. A plurality of bias lines 285 may be electrically connected to a bias line bus or a variable bias reference voltage line 232 which controls a voltage applied to the photodiodes 270. Charge amplifiers 286 may be electrically connected to the data lines 284 to receive signals therefrom. Outputs from the charge amplifiers 286 may be electrically connected to a multiplexer 287, such as an analog multiplexer, then to an analog-to-digital converter (ADC) 288, or they may be directly connected to the ADC, to stream out the digital radiographic image data at desired rates. In one embodiment, the schematic diagram of FIG. 2 may represent a portion of a DR detector 40 such as an a-Si:H based indirect flat panel, curved panel, or flexible panel imager.

Incident x-rays, or x-ray photons, 16 are converted to optical photons, or light rays, by a scintillator, which light rays are subsequently converted to electron-hole pairs, or charges, upon impacting the a-Si:H n-i-p photodiodes 270. An exemplary detector cell 222, or pixel, may include a photodiode 270 having its anode electrically connected to a bias line 285 and its cathode electrically connected to the drain (D) of TFT 271. The integrated signal outputs are transferred from the external charge amplifiers 286 to an analog-to-digital converter (ADC) 288 using a parallel-to-serial converter, such as multiplexer 287, which together comprise modular read-out component 230.

This digital image information may be subsequently processed by processing system 36 to yield a digital image which may then be digitally stored and immediately displayed on monitor 26, or it may be displayed at a later time by accessing the digital electronic memory containing the stored image. The flat panel DR detector 40 having an imaging array as described with reference to FIG. 2 may be capable of both single-shot (e.g., static, radiographic) and continuous (e.g., fluoroscopic) image acquisition.

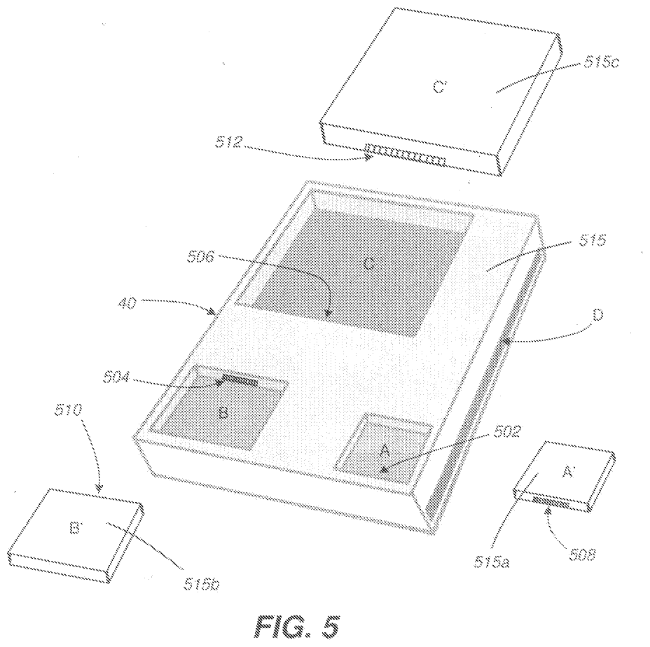

FIG. 3 shows a perspective view of the top (front) side 321 of an exemplary portable wireless DR detector 300 according to an embodiment of DR detector 40 disclosed herein. The DR detector 300 may include a flexible substrate to allow the DR detector to capture radiographic images in a curved orientation. The DR detector 300 may include a housing portion 314 that surrounds a modular component structure comprising a photosensor array portion 12 of the DR detector 300. The housing portion 314 of the DR detector 300 may include a continuous, rigid or flexible, x-ray opaque material or, as used synonymously herein a radio-opaque material, surrounding an interior volume of the DR detector 300. The housing portion 314 may include four flexible edges 318, extending between the top (front) side 321 and the bottom side 322, and arranged substantially orthogonally in relation to the top and bottom sides 321, 322. The bottom side 322 may include openings (A, B, C, FIG. 5) for swapping interchangeable components of the detector 40 as described herein. The top side 321 comprises a top cover 312 attached to the housing portion 314 which, together with the housing portion 314, substantially encloses the modular structure in the interior volume of the DR detector 300. The top cover 312 may be attached to the housing 314 to form a seal therebetween, and be made of a material that passes x-rays 16 without significant attenuation thereof, i.e., an x-ray transmissive material or, as used synonymously herein, a radiolucent material, such as a carbon fiber plastic, polymeric, or other plastic based material.

With reference to FIG. 4, there is illustrated in schematic form an exemplary cross-section view along section A-A of the exemplary embodiment of the DR detector 300 (FIG. 3). For spatial reference purposes, one major surface of the DR detector 400 may be referred to as the top (front) side 451 and a second major surface may be referred to as the bottom (back) side 452, as used herein. The multilayer structure may be disposed within the interior volume 450 enclosed by the housing 314 and top cover 312 and may include a scintillator layer 404 over a two-dimensional imaging sensor array 12 shown schematically as the device layer 402. The scintillator layer 404 may be directly under the substantially planar top cover 312, and the imaging array 402 may be directly under the scintillator 404. Alternatively, a flexible layer 406 may be positioned between the scintillator layer 404 and the top cover 312 to provide shock absorption. The flexible layer 406 may be selected to provide an amount of flexible support for both the top cover 312 and the scintillator 404, and may comprise a foam rubber type of material. The layers just described comprising the multilayer structure each may generally be formed in a rectangular shape and defined by edges arranged orthogonally and disposed in parallel with an interior side of the edges 318 of the housing 314, as described in reference to FIG. 3.

A substrate layer 420 may be disposed under the imaging array 402, such as a rigid glass layer, in one embodiment, or flexible substrate comprising polyimide or carbon fiber upon which the array of photosensors 402 may be formed to allow adjustable curvature of the array, and may comprise another layer of the multilayer structure. Under the substrate layer 420 a radio-opaque shield layer 418 may be used as an x-ray blocking layer to help prevent scattering of x-rays passing through the substrate layer 420 as well as to block x-rays reflected from other surfaces in the interior volume 450. Modular read-out electronics, including the modular scanning component 28, the modular read-out component 30, the modular bias component 32, and processing system 36 (all of FIG. 1) may be formed adjacent the imaging array 402 or, as shown, may be disposed below frame support member 416 in the form of modular components formed as integrated circuits 424, 425. The imaging array 402 may be electrically connected to the read-out electronics (ICs) 424, 425 over a flexible connector 428 which may comprise a plurality of flexible, sealed conductors known as chip-on-film (COF) connectors. The modular electronics 424 may be interchangeably removed/replaced via opening A in housing 314, shown in dotted lines, and the modular electronics 425 may be interchangeably removed/replaced via opening B in housing 314, also shown in dotted lines. In one embodiment, imaging layer(s) forming an imager may be interchangeably removed and replaced through opening D through a slit in the sidewall of housing 314 as explained in more detail herein. The modular imaging layer(s) may include the photosensor array 402 or the photosensor array 402 together with scintillator layer 404.

X-ray flux may pass through the radiolucent top panel cover 312, in the direction represented by an exemplary x-ray beam 16, and impinge upon scintillator 404 where stimulation by the high-energy x-rays 16, or photons, causes the scintillator 404 to emit lower energy photons as visible light rays which are then received in the photosensors of imaging array 402. The frame support member 416 may connect the multilayer structure to the housing 314 and may further operate as a shock absorber by disposing elastic pads (not shown) between the frame support beams 422 and the housing 314. In one embodiment, an external bumper 412 may be attached along the edges 318 of the DR detector 400 to provide additional shock-absorption.

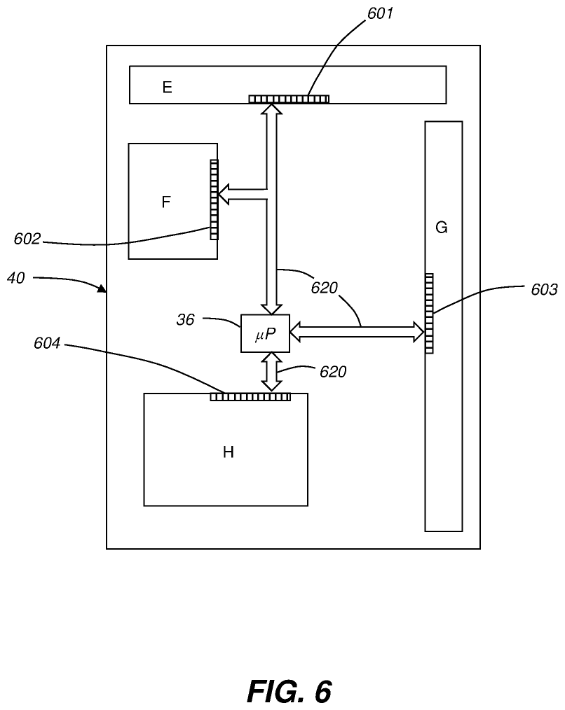

FIG. 5 illustrates a bottom (back) side 515 of the detector having openings A, B, C, each for receiving an exemplary interchangeable modular detector component A′, B′, C′, respectively. Each of the openings A, B, C, includes a system electrical connector 502, 504, 506, respectively, each for electrically engaging a component electrical connector 508, 510, and 512, on a corresponding interchangeable modular detector component A′, B′, C′, respectively. Each of the system electrical connectors 502, 504, 506, include a plurality of conductive transmission lines each corresponding to, and electrically engaging, one of a plurality of conductive transmission lines in the component electrical connector 508, 510, and 512. Thereby, the corresponding modular components A′, B′, C′, are electrically and digitally connected to a processing system (36 of FIG. 1 and FIG. 6) of the detector. At least one of the conductive transmission lines may include a power transmission line for providing power from the detector power source, for example an on-board battery, to the interchangeable modular components A′, B′, C″. Components A′, B′, C′, may be configured such that when they are inserted into the corresponding openings A, B, C, a back surface 515a, 515b, and 515c, of each of the components A′, B′, and C′, respectively, are coplanar with the back surface 515 of the DR detector 40. The modular interchangeable components A′, B′, C′, may each include one of various components, such as detector control electronics, a Wi-Fi communication module, a battery, a processor-battery combination, advanced on-board processing (DSP, FPGA) with associated storage, a second type communication component, an imager to convert x-rays into electronic signals, read-out ICs, analog to digital conversion module, detector control and monitor electronics, a power management system, an image storage unit, and/or a communication interface, each of which may be interchangeably replaced, as shown. In one embodiment, a physical imager component including a photosensor imaging array or an imaging array plus scintillator combination (FIG. 4), may be large enough to occupy almost an entire area of the top (front) side of the detector. Such a physical imager may be inserted into the housing via slot opening D proximate to the top (front) surface of the DR detector 40. The physical imager may include an electrical connector to electrically engage a mating system electrical connector positioned in slot opening D. The physical imager may include an array layer of imaging pixels 402, as described herein, and may be combined together with a seintillator layer 404 attached thereto and, optionally, may also include selected electronics, such as formed on a PCB. The detector 40 may also include a user interface, such as buttons, indication LEDs, and GUI screens.

The integration approach described herein can be based on but not limited to the above critical components. Any further breakdown or combination can be adapted as needed. A standardized design may be included for the base frame/housing and for functional modules relative to size and communication interface electrical connectors. Individual components may be securely authenticated via a verification step using the DR detector processing system before functionalities are enabled. A common design for data communication over a bus 620 (FIG. 6) between different modular components A-D may be integrated. Data communication can be off the shelf, such as USB-C 3.0. The integrated structure maintains the competitive performance from structural design, which includes but is not limited to weight, IP rating, and ruggedness.

FIG. 6 is a schematic illustration, similar in certain respects to FIG. 5, of a plurality of modular components E, F, G, H, having their component electrical connectors electrically engaged with the system electrical connectors at connector locations 601-604, respectively. A processing system 36 of the DR detector 40 may include electronic system memory for storing digital data such as system instructions and radiographic images captured by DR detector 40, as described herein. The processing system 36 may be electrically connected to each of the modules E-H, via a system bus 620 for transmitting and receiving data. Each interchangeable module E-H, may be removed from the DR detector 40 and replaced with the same or an upgraded version of the removed module, as described herein. A replacement module may be detected by the processing system 36 which may be programmed to access identification data from the new module and thereby install the new module for activation and use with DR detector 40.

As will be appreciated by one skilled in the art, aspects of the present invention may be embodied as a system, method, or computer program product. Accordingly, aspects of the present invention may take the form of an entirely hardware embodiment, a software embodiment (including firmware, resident software, micro-code, etc.), or an embodiment combining software and hardware aspects that may all generally be referred to herein as a “service,” “circuit.” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to block diagrams of systems and computer programs according to embodiments of the invention. It will be understood that each block of the block diagrams, and combinations of blocks can be implemented by computer program instructions. These computer program instructions may be provided to a processor of a general purpose computer, special purpose computer, or other programmable data processing system to produce a machine, such that the instructions, which execute via the processor of the computer or other programmable data processing apparatus, create means for implementing the functions/acts specified in the block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the block diagram.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A digital radiographic detector comprising:
a housing having a plurality of openings each for receiving an interchangeable detector intrinsic component;
two or more interchangeable detector components, each of the two or more interchangeable detector components configured to be interchangeable with an identical replacement component or an interchangeable detector component having a different performance.

2. The detector of claim 1, wherein the two or more interchangeable detector components are selected from the group consisting of an imager to convert x-rays into electronic signals, an image readout IC electrically connected to the imager, an analog to digital converter, control module electronics disposed on a PCB, a power management system, an electronic image storage unit, a main processor unit, and a wired or wireless communication module.

3. The detector of claim 2, wherein the imager comprises a two dimensional array of light sensitive pixels and a scintillator.

4. The detector of claim 2, wherein the imager comprises a two dimensional array of x-ray sensitive pixels.

5. The detector of claim 1, wherein the plurality of openings each comprise a system electrical connector and the interchangeable detector components each comprise a component electrical connector, wherein each of the system electrical connectors are configured to electrically engage a corresponding component electrical connector.

6. The detector of claim 5, wherein each of the system electrical connectors are electrically connected to a detector processing system for transmitting signals to and from the detector processing system over the system electrical connectors.

7. A method of swapping a component of a digital radiographic (DR) detector, the method comprising:
removing a modular component of the DR detector from an opening in a back side of the DR detector, including manually detaching a component electrical connector built into the modular component from a system electrical connector built into the opening;
replacing the removed modular component with a replacement modular component, including inserting the replacement modular component into the opening such that a component electrical connector of the replacement modular component electrically engages the system electrical connector built into the opening; and
selecting the replacement modular component from an imager to convert x-rays into electronic signals, an image read-out integrated circuit, an analog to digital converter, control module electronics disposed on a PCB, an image readout IC electrically connected to the imager, an analog to digital converter, control module electronics disposed on a PCB, a power management system, an electronic image storage unit, a main processor unit, a power management system, a memory module, an electronic image storage unit, and a WiFi wireless transceiver,
wherein the system electrical connector is configured to electrically communicate with a processing system of the DR detector.

8. The method of claim 7, further comprising communicating identification data from the replacement modular component to the processing system.

9. The method of claim 8, further comprising communicating digital instructions from the processing system to the replacement modular component.

10. A digital radiographic (DR) detector comprising:
a housing;
a processing system within the housing for controlling operations of the DR detector; and
a plurality of modular components within the housing each in digital communication with the processing system for receiving at least control signals from the processing system and for at least transmitting data to the processing system,
wherein the housing comprises a plurality of openings each corresponding to at least one of the modular detector components.

11. The detector of claim 10, wherein each of the plurality of openings includes a system electrical connector configured to engage a component electrical connector on each of the plurality of modular components.

12. The detector of claim 11, wherein the plurality of modular components are selected from the group consisting of an imager to convert x-rays into electronic signals, an image readout IC electrically connected to the imager, an analog to digital converter, control module electronics disposed on a PCB, a power management system, an electronic image storage unit, and a wired or wireless communication module.

13. The detector of claim 11, wherein the imager comprises a two dimensional array of light sensitive pixels and a scintillator.

14. The detector of claim 11, wherein the imager comprises a two dimensional array of x-ray sensitive pixels.

15. The detector of claim 11, wherein each of the system electrical connectors are electrically connected to the processing system for transmitting signals to and from the processing system over the system electrical connectors.

16. The detector of claim 1, wherein the detector comprises dimensions of 17×17 cm, 35×35 cm, or 35×43 cm.

17. The detector of claim 2, wherein the two or more interchangeable detector components are connected to a power source of the detector.
